(19) United States
(12) Patent Application Publication
(10) Pub. No.: US 2009/0220387 A1
(43) Pub. Date: Sep. 3, 2009

(54) MICRO PUMP DEVICE

(75) Inventors: Yeou-Bin GUU, Taichung City (TW); Jinn-Fa WU, Taichung City (TW); Ming-Fong CHEN, Hsinchu City (TW)

Correspondence Address: RABIN & Berdo, PC, 1101 14TH STREET, NW, SUITE 500, WASHINGTON, DC, 20005, US

(73) Assignee: INDUSTRIAL TECHNOLOGY RESEARCH INSTITUTE, Hsinchu County (TW)

(21) Appl. No.: 12/468,236

(22) Filed: May 19, 2009

Related U.S. Application Data
(63) Continuation-in-part of application No. 10/923,845, filed on Aug. 24, 2004.

(30) Foreign Application Priority Data
Nov. 14, 2003 (TW) 092132070

(51) Int. Cl. B01L 3/02

(52) U.S. Cl. 422/100

(57) ABSTRACT

A micro pump device comprises a structure of chamber with centrally symmetric crossection, a needle compression unit and a traditional fluid extraction and injection unit. The needle compression unit combines with the chamber. The symmetric crossection is utilized to generate fine change in volume for fluid withdraw or discharge. It can be applied as a basic element to products requiring fine fluid withdraw and discharge resolution.

### RELATED APPLICATIONS

This application is a continuation-in-part of U.S. patent application Ser. No. 10/923,845, filed on Aug. 24, 2004.

### BACKGROUND OF THE INVENTION

1. Field of the Invention:

The invention is related to a precision pump that is capable of sucking and discharging a small quantity of liquid. Especially, it refers to a micro pump device that comprises a structure of chamber with centrally symmetrical crossection and a compression unit with a precision piston.

2. Description of the Related Art:

Biomedical research usually involves taking organelles like Mitochondrion out of cells. Traditional technique involves crushing cells and separating out organelles by ultra-high speed centrifugation. If the separation is on a single target cell (such as egg cell), it is performed by a microinjection device. The operation is under a microscope and involves a fine probe piercing an egg cell and sucking out cell sap and organelles by a precision fluid sucking and discharging device. Current microinjection device is a piston-based precision syringe, such as the invention in U.S. Pat. No. 5,225,750.

Since the dimension for a single organelle is about 1 μm, so its volume is about 1 μm³, i.e. 0.001 pl (pico liter or 10⁻¹² liter). To achieve precise withdraw of a single organelle requires precise control over the withdrawn liquid quantity for the single organelle.

Because of U.S. Pat. No. 5,225,750, the precision syringe for the Microinjection device controls cylinder volume through shifting a precision piston. The cylinder volume change is equal to cylinder cross section area times piston moving distance. Given the fact that a fine cylinder is hard to make, a cylinder with 1 cm in crossectional diameter only takes a moving distance of 1.3×10⁻⁹ cm to obtain a withdraw resolution of 0.001 pl. This moving distance is only one hundredth of atomic diameter. A very short moving distance for a piston is not attainable. Thus, current microinjection device cannot achieve a withdraw resolution of 0.001 pl.

The invention is related to a precision device that enables a very fine withdraw resolution (such as 0.001 pl). As a fundamental device, it can be applied to products that need fine withdraw resolution.

### SUMMARY OF THE INVENTION

The objective of the invention is to provide a micro pump device with fine suction and withdraw resolution that attains 0.001 pl or finer.

Another objective of the invention is to provide a clean and non-contaminating micro pump device as an organelle withdraw system.

The micro pump device that can achieve the above objectives with fine resolution comprises a structure of chamber with centrally symmetrical crossection, a syringe compression unit and a fluid extraction and injection unit.

When the centrally symmetrical chamber (such as circle, square 9 etc.) is under compression, its area changes slightly. Refer to FIG. 3 for an example of square 9. When two non-neighboring angles in a square are under compression, the square 9 is transformed into a diamond 10. When the moving distance due to compression compared to the side of the square 9 is relatively small, the area change due to transformation of the square 9 into the diamond 10 is about the square of two times of the moving distance (r−a). The area change for a shape with symmetrical compression center is the square of the moving distance (r−a) times a constant. Such a principle can be applied to a structure of chamber with any centrally symmetrical crossection. The glass tube in the present invention is one structure of chamber with centrally symmetrical crossection. Outside the tube, a piezoelectric actuator is used as the compression tube wall element. Through the fine control over the piezoelectric actuator for the moving distance under compression, the objective of fine fluid withdraw and suction resolution can be achieved.

### BRIEF DESCRIPTION OF THE DRAWINGS

The drawings disclose an illustrative embodiment of the present invention that serves to exemplify the various advantages and objects hereof, and are as follows:

FIG. 1 is an illustration for a micro pump device.

FIG. 2 is an illustration for a structure of chamber and a syringe compression unit.

FIG. 3 is the geometric illustration for the area change for a square.

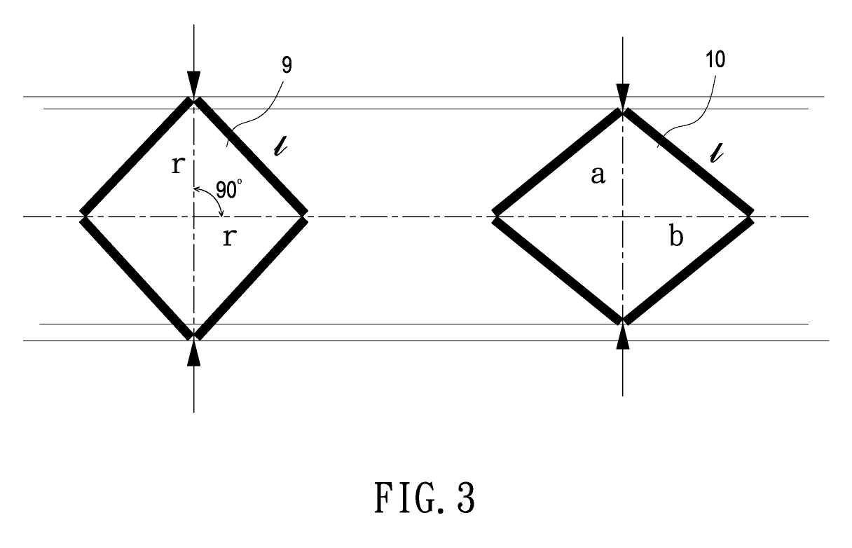

FIG. 4 is the geometric illustration for the area change for a circle.

FIG. 5 is an illustration for the status of a micro pump in use.

FIG. 6 is the geometric illustration for the volume change for a chamber from a sphere to an ellipsoid.

FIG. 7a is an illustration for a chamber.

FIG. 7b is an operational example for a chamber.

FIG. 8 is the geometric illustration for a small change on a multifacial pyramid.

### DETAILED DESCRIPTION OF THE INVENTION

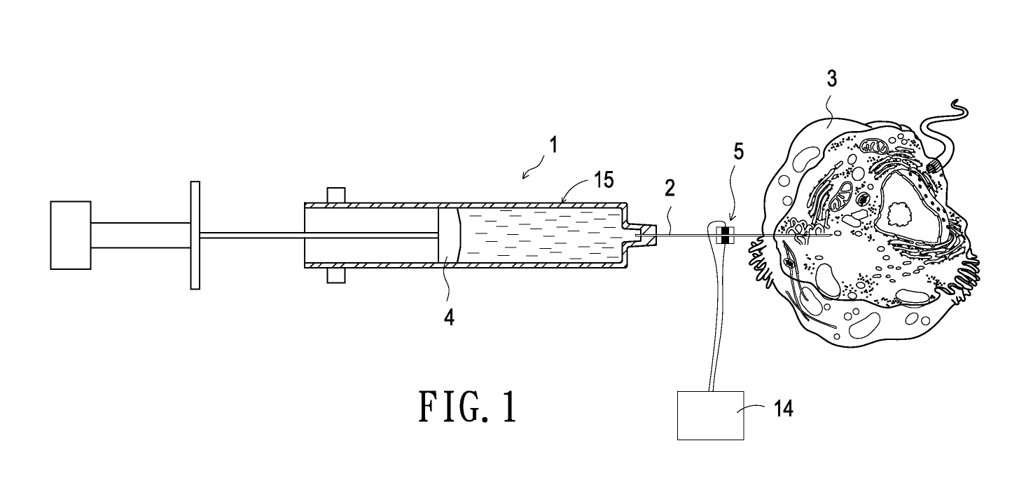

Please refer to FIG. 1 for an illustration for a micro pump device in the present invention, which comprises a fluid extraction and injection unit 1 for control over injection and extraction action of fluid, a micro-needle 2 that has a structure of chamber with centrally symmetrical crossection and such a micro-needle 2 can be a bi-axially symmetrical tube with two fluid openings, one connecting to the exit of the above fluid extraction and injection unit 1, and a syringe compression unit 5 that lies against the exterior of the above micro-needle 2 and has a support and a compression tube wall unit 7.

Among these units, the fluid extraction and injection unit 1 is an injection syringe tube 15 with back end connecting to the micro-needle 2. The fluid extraction and injection unit 1 has a piston 4. When the piston 4 is pulled until the micro-needle 2 is filled with fluid, the piston 4 position remains unchanged, so the volume for the entire device also remains unchanged and the micro-needle 2 becomes a container with a single opening at the needle tip.

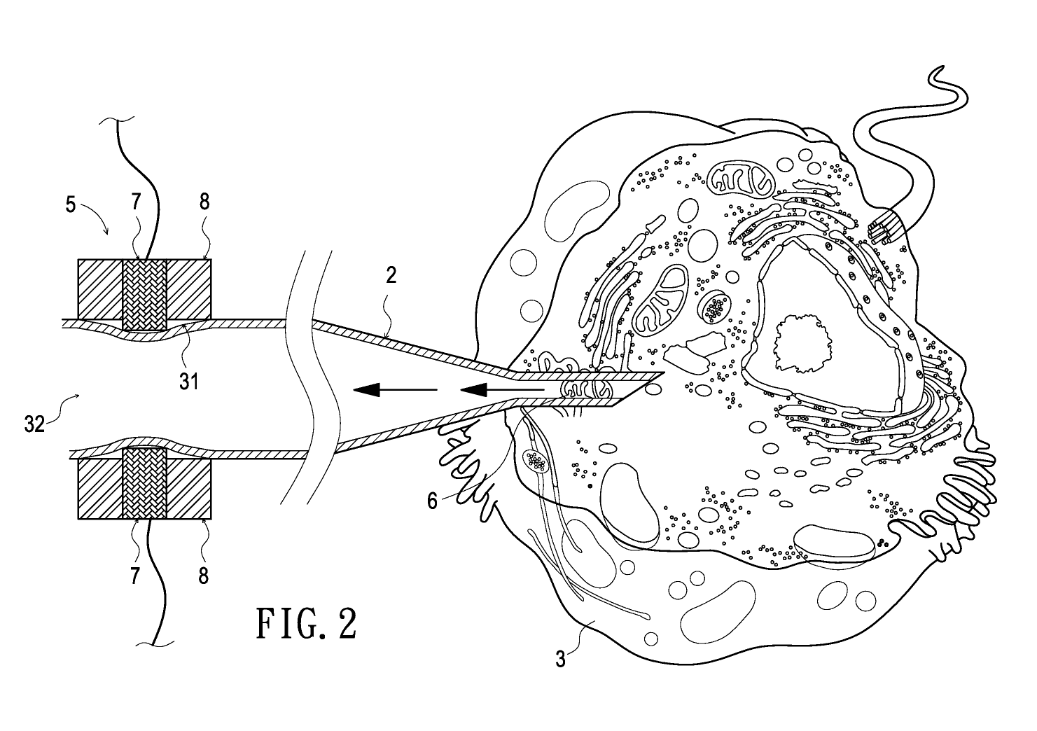

Please refer to FIG. 2 for a cross section view of micro-needle and a syringe compression unit. The syringe compression unit 5 is a ring shape and is located at the periphery of the micro-needle 2. The needle support 8 secures the micro-needle 2 and the compression tube wall unit 7, so the compression tube wall unit 7 pushes the micro-needle 2 to change the volume in the micro-needle 2 and provides a compression resolution finer than 10 nm. In the current example the compression tube wall unit 7 is a ring type piezoelectric actuator and the resolution is 1 nm.

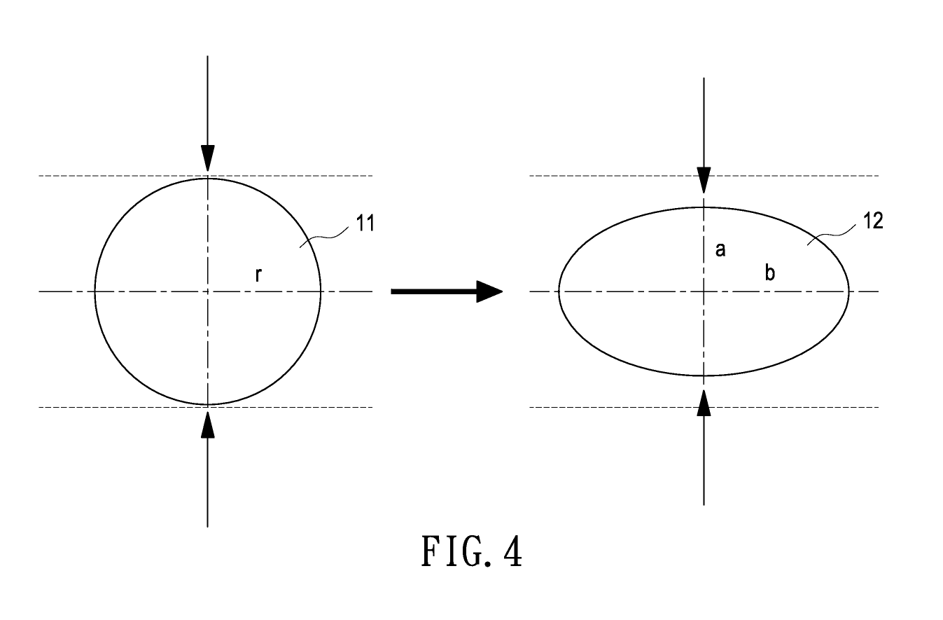

Please refer to FIG. 4. When a circle 11 is under a small compression, the area change is about π times the square of the moving distance. If a cross section circle 11 for a cylinder moves 10 nm due to compression, the area change is 1π×10⁻¹⁶m². Assuming the moving distance due to compression in a cylinder is 3 mm, the volume change will be 1π×10⁻¹⁶m²×3 mm=10×10⁻¹⁹m³=1×10⁻¹⁵ liter=0.001 pl. If the moving distance under compression is 1μ m, the volume change will be 1π×10⁻¹²m²×3 mm=1×10⁻¹¹ liter=10 pl. The invention offers control over volume change from 0.001 pl to 10 pl.

Please refer to FIG. 1 and FIG. 2 for an illustration for a micro pump device and an illustration for a micro-needle and a syringe compression unit. During use, the fluid extraction and injection unit 1 fills the micro-needle 2 with fluid and keeps bubbles out of the micro-needle 2. The fluid extraction and injection unit 1 also closes out and makes the micro-needle 2 to become a container with a single opening at the needle tip.

Electric signal input device 14 drives the compression tube wall unit 7 at the periphery of the micro-needle 2, which then is subject to compression and shrinks in volume. FIG. 2 shows a micro-needle 2 is under compression by the tube wall unit 7 and the partial crossection of the micro-needle 2 changes from a circle 11 into an ellipse 12. The volume of the micro-needle 2 shrinks and the opening at the tip starts discharging a little liquid. When piercing the cell 3 and the opening at the tip approaching the target organelle 6, the compression tube wall unit 7 is loosened and the volume of the micro-needle 2 expands to create suction effect. The compression tube wall unit 7 is actuated to compress the tube wall 31 leading to a decrease in volume in the structural chamber 32 and the resolution of volume change is between 10 pl and 4.2×10-9 pl.

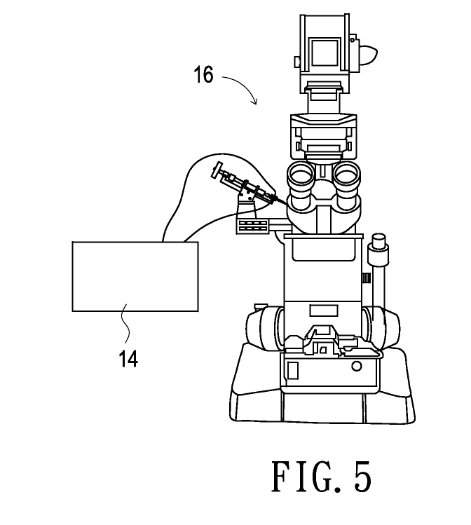

Please refer to FIG. 5 for an illustration for the status of a micro pump in use. The micro pump is fixed on one side of a microscope 16 platform. The liquid suction by the micro pump is controlled by monitoring the movement of the needle tip through the microscope 16.

Regarding whether glass tube breaks under compression, the test was conducted to press 1 mm O.D. glass tube for 10μ m in deformation by a micrometer. The glass tube did not break and returned to the original state after micrometer was released. Apparently, 10μ m compression is still within the elastic deformation for glass tube.

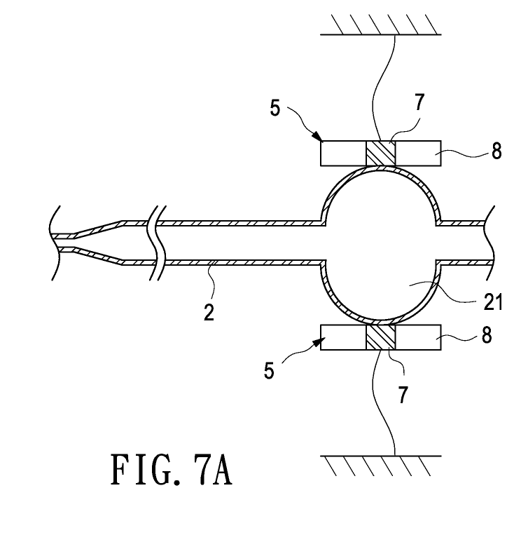

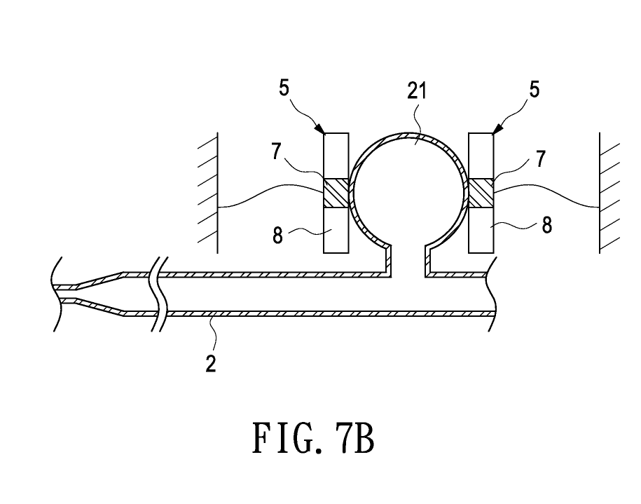

Please refer to FIG. 7a for another example for the present invention. At the proper location on the micro-needle 2, there is a spherical chamber 21 that is axially symmetrical on two sides of inner wall.

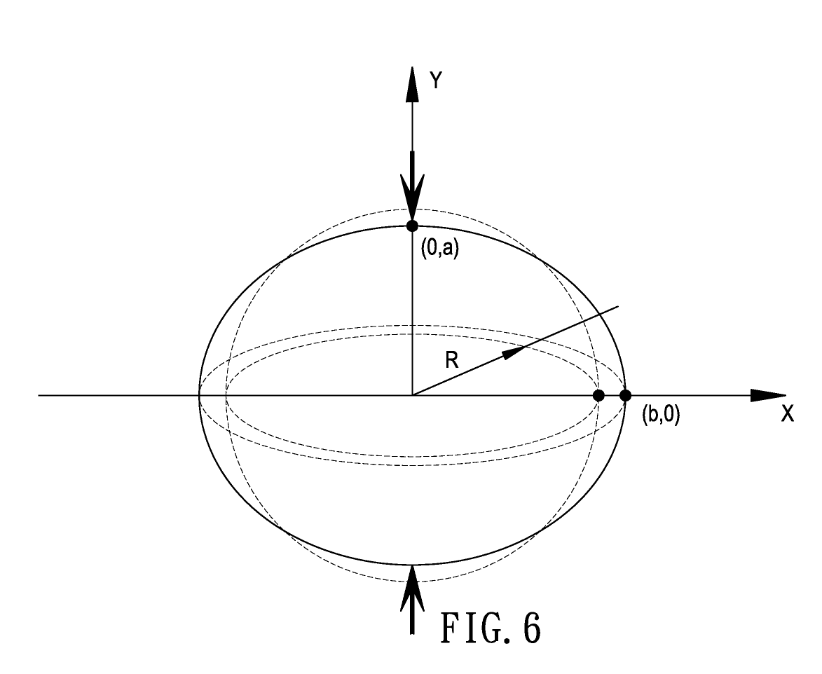

In operation, as in FIG. 6 and FIG. 7a, the compression tube wall device 7 for the syringe compression unit 5 presses the periphery of the chamber 21 on the micro-needle 2. As a result, the crossection of the chamber 21 changes from centrally symmetrical shape into a slightly flatten shape.

Please refer to FIG. 7b for another example for the present invention. The spherical chamber 21 sticks out from one side of the inner wall of the micro-needle 2.

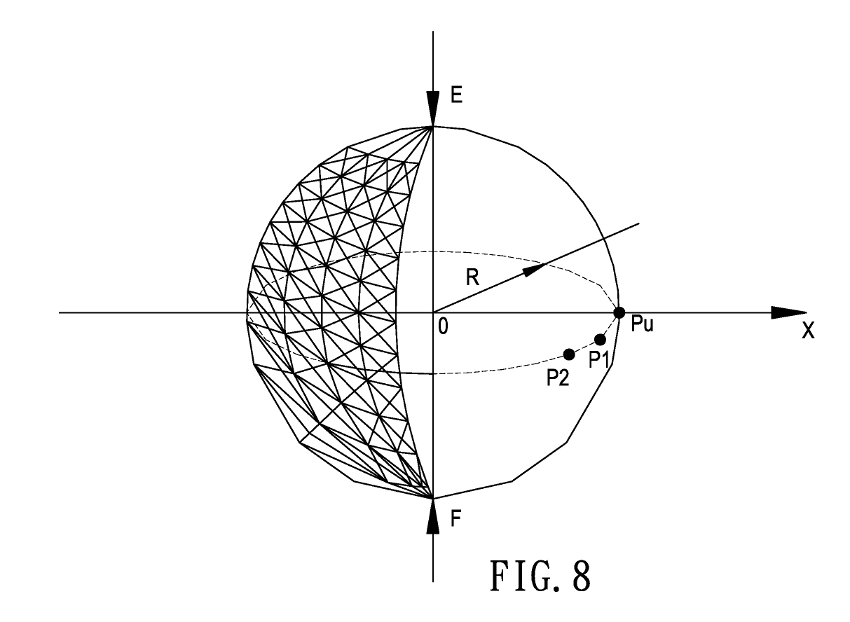

Refer to FIG. 8 for another example for the present invention. The chamber 21 is a multifacial pyramid. In the figure, P1, P2 . . . and Pn form a polygon. E and F are the positions where compression tube wall unit 7 exerts compressive force. The force acts on F and F towards the center 0 of the polygon P1, P2 . . . and Pn. As a result, the entire multifacial pyramid surface changes with height between E and F from a triangle to a curve.

When the micro pump device in the present invention is compared to other traditional devices, it has an additional piezoelectric actuator on the micro-needle 2 of the centrally symmetrical crossection. Therefore, the withdraw liquid can be controlled to 0.001 pl. The invention meets the innovation requirement.

FIG. 6 shows the crossection changes from a centrally symmetrical shape to a slightly flatten shape. The volume change in the chamber 21 is the cubic of the compression Z times 4π/3. If a spherical chamber is under 10 nm compression by the tube wall unit 7 and becomes an ellipsoid, its volume change will be 4/3×π×10⁻²⁴m³♮4.2×10⁻⁹ pl. If the compression is 1 μ, the volume change will be 4/3×π×10⁻¹⁸m³≈4.2×10⁻³ pl. Thus, volume change is further minimized from 4.2×10⁻⁹ pl to 10 pl.

The above example gives a detailed description for the present invention. However, the example does not intend to limit the scope of the invention.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

What the invention claimed is:

1. A micro pump device, comprising:
a fluid extraction and injection unit, the fluid extraction and injection unit including an injection syringe tube and a piston, the injection syringe tube having a first open end ,and a second end directly coupled to a micro-needle, the piston moved closely inside injection syringe tube at the first open end of the injection syringe tube;
the micro-needle coupled to the injection syringe tube, the micro-needle having a first fluid opening and a second fluid opening, the first fluid opening of the micro-needle directly coupled with the second end of the injection syringe tube, the micro-needle generally defined by a bi-axially symmetrical tube forming a structural chamber with centrally symmetric cross-sectional portions; and
a compression tube wall unit proximate the periphery of the micro-needle, the compression tube wall unit defined by a ring type piezoelectric actuator, wherein the compression tube wall unit is actuated to compress the tube wall leading to a decrease in volume in the structural chamber of micro-needle and the resolution of volume change is between 10 pl and 4.2×10-9 pl.

2. The micro pump device of claim 1 wherein the centrally symmetrical cross-sectional portions are circular or rectangular when not compressed.

3. The micro pump device of claim 1, further comprising:
an electric signal input device connected to the compression tube wall unit for driving compression by providing an electric signal.

4. The micro pump device of claim 1 wherein the micro-needle is glass, silicon or metal.

5. The micro pump device of claim 1 wherein the compression of the tube wall produces a resolution for fluid withdraw and discharge finer than 10 nm.
